(19) United States
(12) Patent Application Publication
(10) Pub. No.: US 2011/0095247 A1
(43) Pub. Date: Apr. 28, 2011

(54) LOCKING ASSEMBLY FOR LIFTING APPARATUS

(76) Inventor: WILLIAM MARK ADAMS, RETFORD (GB)

(21) Appl. No.: 12/912,082

(22) Filed: Oct. 26, 2010

(30) Foreign Application Priority Data
Oct. 26, 2009 (GB) GB 0918754.3

(51) Int. Cl. B66F 3/00

(52) U.S. Cl. 254/133 R

(57) ABSTRACT

The invention relates to a locking assembly for use with lifting apparatus which includes a platform which is movable with respect to guide means. The locking assembly is provided in an unlocked condition during normal operation of the lifting apparatus but, when failure of movement means for the platform occurs such as to allow an uncontrolled movement of the platform the locking assembly is caused to move to a locked position with respect to the guide means so as to prevent further uncontrolled movement of the platform, and therefore prevent damage to goods and/or personnel which may be on the platform at the time of failure of the movement means.

### CROSS-REFERENCE TO RELATED APPLICATIONS

This application claims priority under 35 U.S.C. § 119 to application GB 0918754.3 filed Oct. 26, 2009, herein incorporated by reference in its entirety.

### BACKGROUND OF THE INVENTION

The invention relates to lifting apparatus and, in particular apparatus which can be used to transfer goods between first and second goods storage areas.

Lifting apparatus can be used for many purposes and the applicant has several granted patents and patent applications relating to lifting apparatus which can be used to efficiently transfer goods between a first goods storage area, such as a vehicle goods trailer, and a second goods storage area such as a goods warehouse.

The movement of goods between storage areas is required to be performed efficiently, quickly and safely and problems are experienced in being able to provide suitable apparatus to perform this which can meet operating requirements while, at the same time ensuring that the apparatus itself can be installed quickly and into relatively confined spaces at, for example, loading bays. The applicant, in their co-pending application EP 06255129.6 discloses apparatus which can be provided in a modular form to the site of use and then assembled on site. The apparatus includes a platform which is provided to support goods thereon. The platform is positioned between a set of pillars which act as guide means, and suspended from a series of chains or ropes which are located with the guide means. The chains or ropes are wound and unwound, typically as a result of movement of a common hydraulic ram, and the winding or unwinding of the ropes or chains allows the movement of the platform upwardly or downwardly along the guide means along a vertical axis.

While the apparatus of the type described above works effectively there is a need for this apparatus, and other apparatus used for the same purpose, to be safe in use and in particular for it to be safe if there is a malfunction of the movement means for the platform, so as to prevent the platform from falling in an uncontrolled manner or falling for a significant distance. The safety is required in terms of preventing injury to persons who may be on the platform at the time of failure and/or to prevent damage to goods which are on the platform at that time.

### SUMMARY OF THE INVENTION

The aim of the present invention is therefore to provide lifting apparatus which includes means to allow the position of the platform with respect to the apparatus and the adjacent goods storage areas to be controlled and secured in position should failure of the lifting means for the platform fail.

In a first aspect of the invention there is provided lifting apparatus, said apparatus comprising a platform located to be movable with respect to a plurality of guide means, movement means to control the movement of the platform and at least one locking assembly which is selectively operable to lock the platform in a position with respect to the guide means wherein said locking assembly is operable when failure of the movement means occurs so as to control the subsequent movement of the platform.

In one embodiment the locking assembly operates automatically upon a failure of the movement means is detected.

In one embodiment the movement means includes a plurality of elongate members, each having a free end connected at a location on the platform, said elongate members operated on by a drive means such that the platform is raised or lowered along said guide means. In one embodiment the drive means is a ram which acts on each of the elongate members.

In one embodiment the elongate members are a rope or chain. In one embodiment the breakage of the elongate member and/or failure of the drive means is the occurrence which causes the operation of the locking assembly.

In one embodiment each of the elongate members is connected to the platform via an anchor bracket which is held in tension by the elongate member and platform in normal operating conditions. However should the drive means or elongate member fail, the anchor bracket moves so as to release the locking assembly and prevent further movement of the platform with respect to the guide means.

In one embodiment the guide means include a rack along at least part of the length thereof and typically along that portion of the guide means along which the platform can be moved. This rack forms part of the locking assembly which further includes, for each rack, a pawl, and a biasing means, typically in the form of a compression spring. Typically, in normal operating conditions the spring remains in compression and it is only when the anchor bracket moves upon the occurrence of a failure of the elongate members and/or drive means that the spring is released.

Typically the release of the spring causes the pawl to pivot and engage with at least one of the teeth of the rack. Typically the number and spacing of the teeth on the rack is such that the movement of the platform following failure of the movement means and prior to engagement with the rack is within a predetermined acceptable distance such that the risk of injury or damage due to uncontrolled movement of the platform is minimised.

Typically the locking assembly, with the exception of the rack, is located so as to move with the platform in normal operation of the apparatus. Typically an anchor bracket of each locking assembly acts as the interface between an elongate member and the platform.

Typically a locking assembly as herein described is provided for each of the elongate members which is connected to the platform.

Typically if one of the plurality of elongate members fails then at least the locking assembly for that elongate member will be actuated to thereafter prevent uncontrolled downward movement of the platform as a whole. In one embodiment the sudden change in movement of the platform caused by one or a number of the elongate members is sufficient to cause the operation of all of the locking assemblies.

In a further aspect of the invention there is provided lifting apparatus, said apparatus including a platform moveable in a substantially vertical axis, said platform connected to movement means and at least one locking assembly, said locking assembly maintained in a first condition when movement of the platform is under the control of the movement means and wherein said locking assembly is moved to a second condition when failure of the movement means occurs such as to lock the platform in position at or substantially adjacent to the height of the platform at the time of failure.

In a yet further aspect of the invention there is provided a locking assembly for lifting apparatus including a movable platform, said assembly including a toothed rack mounted in a fixed position and extending along the range of movement of the platform, and a pawl located to move with the platform and wherein upon movement of the platform at or in excess of a predetermined rate of movement, the locking assembly is operated to move the pawl to locate with the rack and prevent further movement of the platform.

Typically the locking assembly includes a biasing means, said biasing means released by the occurrence of the predetermined rate of movement of the platform to exert a moving force on the pawl.

### BRIEF DESCRIPTION OF THE DRAWINGS

Specific embodiments of the invention are now described with reference to the accompanying drawings; wherein

FIG. 1 illustrates a perspective view of lifting apparatus with which the invention as herein described can be used;

FIGS. 2a-d illustrate a number of views of a locking assembly in accordance with the invention in use with the platform of the lifting apparatus of FIG. 1;

FIG. 3 illustrates a perspective view of the locking assembly of FIGS. 2a-d;

FIG. 4 illustrates the locking assembly of FIG. 3 in a first condition; and

FIG. 5 illustrates the locking assembly of FIG. 3 in a second condition.

### DETAILED DESCRIPTION OF THE PREFERRED EMBODIMENT

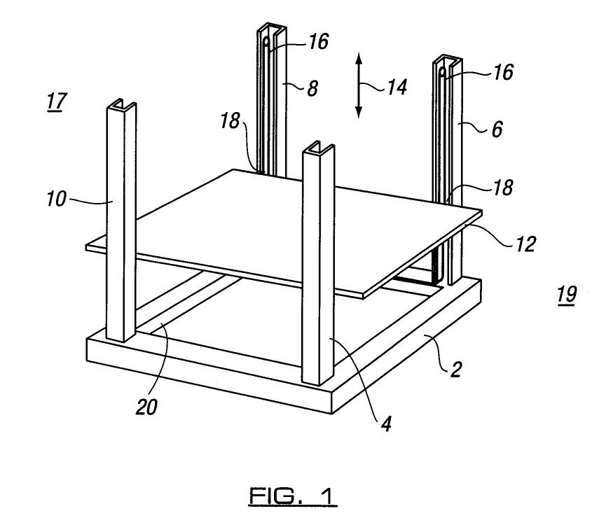

Referring firstly to FIG. 1 there is illustrated an example of the main components of one embodiment of lifting apparatus with which the current invention may be utilised. The apparatus includes a frame 2 which includes a plurality of guide means 4, 6, 8, 10. A platform 12 is provided to be movable with respect to the guide means along the vertical axis 14. The movement of the platform is controlled by a plurality of elongate members 16, typically in the form of ropes or chains. Typically an elongate member is provided at each of the guide means and have a free end 18 connected to the platform to support the same. The opposing free end is located with respect to drive means 20 which typically comprise a hydraulic ram (not shown). The extent of movement of the ram controls the length of each of the elongate members 16 at any given time and, as a result, the height of the platform with respect to the guide means. Lengthening or shortening of the elongate members by movement of the hydraulic ram causes lowering or raising of the platform with respect to the guide means. The apparatus is typically provided to be used in conjunction with first and second goods storage areas 17, 19 which may, in one example, comprise a vehicle trailer 17 and a warehouse 19. The goods are required to be moved between the storage areas via the platform which can be raised and lowered. It should be appreciated that there will typically be provided other items for use on the lifting apparatus, and possibly other drive means and that the embodiment shown in FIG. 1 is in a format best suited to illustrate the key components with respect to the utilisation of the invention.

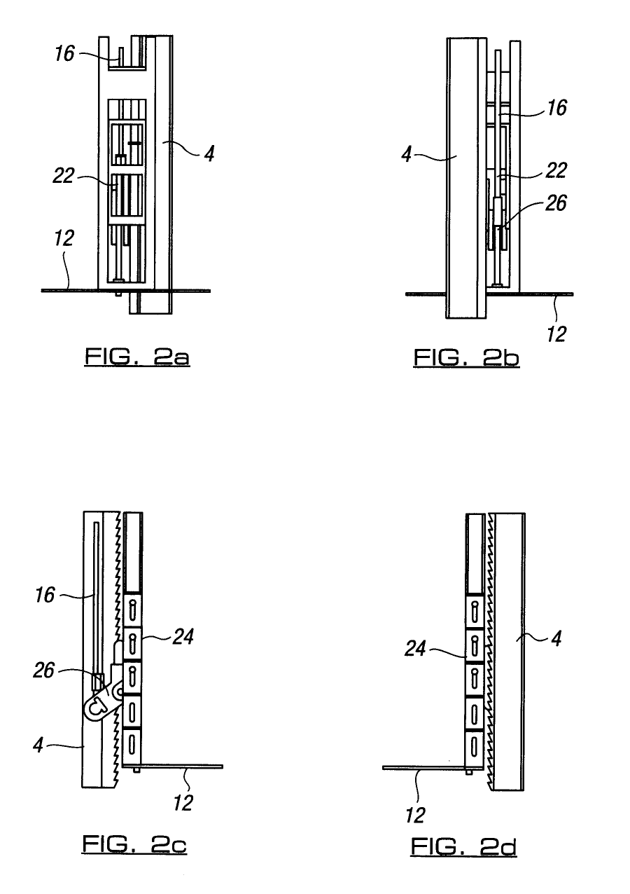

Referring now to FIGS. 2a-d there is illustrated one of the guide means 4 with an associated locking assembly 22 provided in accordance with the invention. In this arrangement the platform 12 is located with a member 24 and is connected to an elongate member in the form of steel rope 16 via an anchor bracket 26 connected to the member 24.

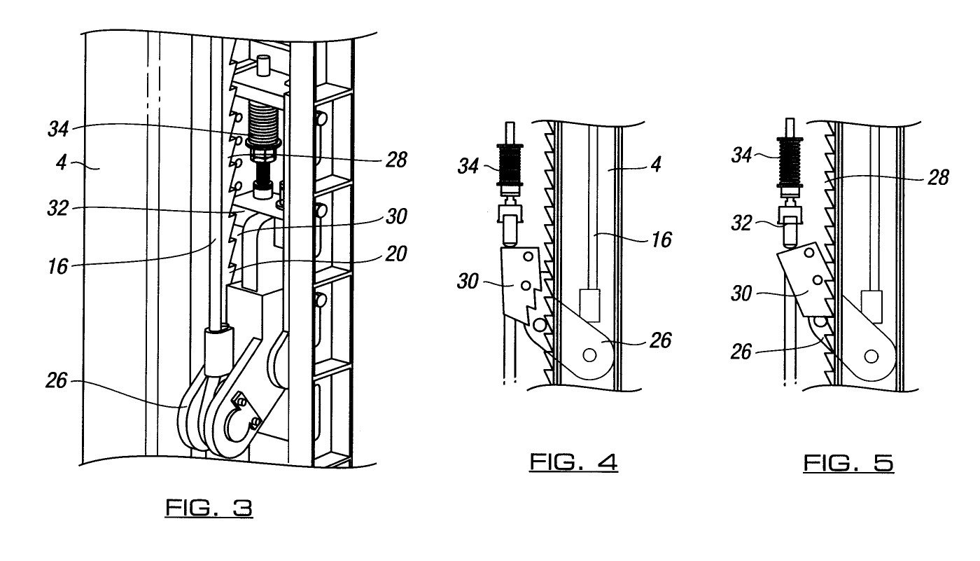

The anchor bracket 26 is pivotally movable and is held in a first position in tension, when the elongate member is being operated in the normal way. The anchor bracket moves it's position when the elongate member has failed and the manner in which this occurs is now described with regard to FIGS. 3-5.

Referring now to FIG. 3 there is provided a more detailed view of the arrangement shown in FIGS. 2a-d. The guide 4 includes mounted thereon a rack 28 which includes a series of teeth formations 29 at spaced intervals there along. The rack typically extends along that portion of the guide means which the platform can be moved. The rack 28 forms part of the locking assembly which also includes a pawl 30 which is selectively moved under the force of actuator 32 which is in turn operated by the movement of the biasing means 34 in the form of a compression spring, when the spring is released. The anchor bracket 26 is also shown in connection with the elongate member 16.

FIG. 4 illustrates the apparatus in a “normal” operating mode in which the elongate member 16 is in connection with the drive means and the anchor bracket 26 and the movement of the platform is therefore under the control of the movement means and is operating safely. In this condition the anchor bracket acts on the compression spring 34 to maintain the same in a compressed state and so, in turn, the pawl 30 is held in the retracted, non-locking position shown in FIG. 4. With the locking assembly in this position the platform is free to move along the guide means 4 under the influence of the movement means and be moved to the required heights to allow the movement of goods and/or people to and from the platform. It should be appreciated that this arrangement is repeated for each of the guide means.

In operation, should, for example, the elongate member 16 fail or break, or the drive means fail then, in conventional apparatus without the locking assembly of the invention, there is a risk that the platform which would no longer be controlled could fall a significant distance quickly which could cause injury and/or damage to persons and/or goods on the platform at that time and/or person adjacent to the apparatus. However, by providing the invention as herein described this is avoided as will now be explained.

Upon the occurrence of a failure of the elongate member or drive means, there is a loss of tension on the anchor bracket 26 as the same is no longer held by the elongate member. This loss of tension causes the anchor bracket 26 to move from the position shown in FIG. 4 to the position shown in FIG. 5. This movement, in turn, causes the release of the compression spring 34 so that the same extends in length as shown in FIG. 5. This extension moves the actuator 32 to move the pawl 30 to contact with the adjacent teeth 29 of the rack 28 and hence lock with the same. The locking of the pawl with the teeth on the rack immediately prevents any further downward movement of the platform with respect to the guide means. As the failure of the elongate member or drive means can be instantaneous, the locking assembly as herein described will operate immediately and automatically upon the occurrence of the failure. This means that the movement of the platform in an uncontrolled manner downwardly will be prevented completely or at least to movement a very limited extent by the automatic operation of the locking assembly.

Thus, in accordance with the invention, any failure of the movement means which would cause the uncontrolled movement of the platform is detected and the locking system of the invention is operated automatically so as to lock the platform at or substantially at the same height as when the failure occurred and thereby prevents any uncontrolled and potentially hazardous movement of the platform.

1. Lifting apparatus, said apparatus comprising a platform located to be movable with respect to a plurality of guide means, movement means to control the movement of the platform and at least one locking assembly which is selectively operable to lock the platform in a position with respect to the guide means wherein said locking assembly is operable when failure of the movement means occurs so as to control the subsequent movement of the platform.

2. Apparatus according to claim 1 wherein the locking assembly operates automatically upon failure of the movement means being detected.

3. Apparatus according to claim 1 wherein the movement means includes a plurality of elongate members, each having a free end connected at a location on the platform and said elongate members are operated on by a drive means to cause the movement of the platform along said guide means.

4. Apparatus according to claim 3 wherein failure of an elongate member and/or failure of the drive means causes operation of the locking assembly to lock the platform in a fixed position.

5. Apparatus according to claim 3 wherein the elongate members are connected to the platform via an anchor bracket of the locking assembly which is held in a first condition by the elongate member and platform in normal operating conditions.

6. Apparatus according to claim 1 wherein the locking assembly includes a rack which is located along at least part of a guide means and for each rack, a pawl and a biasing means.

7. Apparatus according to claim 6 wherein in normal operating conditions, the biasing means is held in compression and if a failure of the drive means or elongate member occurs, the biasing means is released from compression to cause operation of the locking assembly.

8. Apparatus according to the claim 7 wherein the release of the biasing means causes the pawl to pivot and engage with at least one of the teeth of the rack.

9. Apparatus according to claim 6 wherein the number and spacing of the teeth on the rack is selected such that possible movement of the platform following failure of the drive means and/or elongate member and prior to engagement of the rack with the pawl to stop movement of the platform is within a predetermined limit.

10. Apparatus according to claim 1 wherein the locking assembly, with the exception of the rack, is located and moves along with the platform in normal operation of the apparatus.

11. Apparatus according to claim 1 wherein a locking assembly is provided for each of the elongate members connected to the platform.

12. Apparatus according to claim 1 wherein if one of the elongate members fails then at least the locking assembly for that elongate member is actuated to thereafter prevent uncontrolled downward movement of the platform.

13. Lifting apparatus, said apparatus including a platform moveable in a substantially vertical axis, said platform connected to movement means and at least one locking assembly, said locking assembly maintained in a first condition when movement of the platform is under the control of the movement means and wherein said locking assembly is moved to a second condition when failure of the movement means occurs such as to lock the platform in position at or substantially adjacent to the height of the platform at the time of failure.

14. A locking assembly for lifting apparatus including a movable platform, said assembly including a toothed rack mounted in a fixed position and extending along the range of movement of the platform, and a pawl located to move with the platform and wherein upon movement of the platform at or in excess of a predetermined rate of movement, the locking assembly is operated to move the pawl to locate with the rack and prevent further movement of the platform.

15. A locking assembly according to claim 14 wherein the assembly includes a biasing means said biasing means released by the occurrence of the predetermined rate of movement of the platform to exert a moving force on the pawl.
